(19) United States
(12) Patent Application Publication
(10) Pub. No.: US 2024/0328077 A1
(43) Pub. Date: Oct. 3, 2024

(54) USE OF FILM-FORMING ORGANOPOLYSILOXANES FOR REDUCING THE MICROFIBER RELEASE OF TEXTILES

(71) Applicant: Wacker Chemie AG, Munich (DE)

(72) Inventors: Christof BREHM, Burghausen (DE); Peter HORVATH, Budapest (HU)

(73) Assignee: Wacker Chemie AG, Munich (DE)

(21) Appl. No.: 18/578,019

(22) PCT Filed: Jul. 13, 2021
(86) PCT No.: PCT/EP2021/069424

§ 371 Date: Jan. 10, 2024

(51) Int. Cl. D06M 15/643; D06M 13/467; D06M 13/507; D06M 23/10

(52) U.S. Cl. CPC D06M 15/6436; D06M 13/467; D06M 13/507; D06M 23/10; D06M 2200/35

(57) ABSTRACT

A process for reducing the release of microfibers during the washing process of textiles includes a composition (Z). The textiles are pretreated before the washing process with composition (Z), which includes at least 0.1 parts by weight and not more than 10.0 parts by weight of film-forming organopolysiloxanes, at least 1 part by weight and not more than 20 parts by weight of cationic surfactants, and at least 30 parts by weight and not more than 99 parts by weight of water.

The invention relates to a process for reducing the release of microfibers during the washing process of textiles by pretreatment with film-forming organopolysiloxanes.

Many formulations are used in “consumer products” in order to achieve a particular benefit. Examples are particular softness, improved tactile properties or the reduction of wrinkles.

Typically, formulations of this kind comprise water-insoluble, quaternary ammonium compounds having generally at least two long-chain alkyl or alkenyl chains. Owing to their better biodegradability, there has been increasing interest in those quaternary ammonium compounds that comprise long-chain alkyl or alkenyl groups interrupted by functional groups, such as carboxyl groups. Compounds of this kind have long been known and are described for example in U.S. Pat. No. 3,915,867.

Also known are formulations comprising combinations of cationic emulsifiers and functionalized polydiorganosiloxanes, for example amino-functionalized polydiorganosiloxanes, polydiorganosiloxanes with quaternary functionalizations or hydroxypropylamino-functionalized polydiorganosiloxanes. Formulations of this kind are described for example in WO2011/123727A2.

The release of microplastic into the environment is one of the most urgent environmental problems. A considerable proportion of the microplastic is made up of microfibers, for example from polyester fabrics, which are released during everyday wear, but especially during the washing process.

The problem described and also possible solutions are summarized, among others, by N.J. Lant et al. in PLOS ONE 15 (6): e0233332.https://doi.org/10.1371/journal.pone.0233332 (Jun. 5, 2020). This article shows that fabric softeners do not have any direct influence on the release of microfibers.

The invention provides a process for reducing the release of microfibers during the washing process of textiles which are pretreated before the washing process with composition (Z) comprising
(A) at least 0.1 parts by weight and at most 10.0 parts by weight of film-forming organopolysiloxanes,
(B) at least 1 part by weight and at most 20 parts by weight of cationic surfactants and
(C) at least 30 parts by weight and at most 99 parts by weight of water.

It has surprisingly been found that the compositions (Z) comprising film-forming organopolysiloxanes and cationic surfactants have a positive, that is to say reducing, effect on the release of microfibers in the washing process.

Preference is given to using compositions comprising at least 0.25 parts by weight, more preferably at least 0.4 parts by weight, and preferably at most 5 parts by weight, more preferably at most 3 parts by weight, of film-forming organopolysiloxanes (A).

The composition preferably comprises at least 1.5 parts by weight, more preferably at least 2.5 parts by weight, and preferably at most 15 parts by weight, more preferably at most 10 parts by weight, of cationic surfactants (B).

The composition preferably comprises at least 45 parts by weight, more preferably at least 60 parts by weight, and preferably at most 97 parts by weight, more preferably at most 95 parts by weight, of water (C).

The film-forming organopolysiloxanes (A) are preferably used in the form of their aqueous emulsions.

The composition (Z) preferably comprises an oil-in-water emulsion of film-forming or-ganopolysiloxanes (A) that comprises
(i) 100 parts by weight of aminoalkyl group-containing polyorganosiloxane (P) that is liquid at 20° C. and comprises at least 80 mol % of units selected from units of the general formulae Ia, IIb, IIa and IIb

R¹₂SiO_{(2/2)}, (Ia)

R¹ₐR²SiO_{(3-1)/2}, (Ib)

R³₃SiO_{(1/2)}, (IIa)

R³₂R⁴SiO_{(1/2)}, (IIb)

in which
a is 0 or 1,
R¹ is unsubstituted alkyl radicals having 1-40 carbon atoms,
R² is an aminoalkyl radical of the general formula III

—R⁵—NR⁶R⁷ (III)

where
R⁵ is a divalent hydrocarbon radical having 1-40 carbon atoms,
R⁶ is a monovalent hydrocarbon radical having 1-40 carbon atoms, hydrogen or an alkanoyl radical and
R⁷ is a radical of the general formula IV

—(R⁸—NR⁶)ₓR⁶, (IV)

where
x is an integer from 0 to 40 and
R⁸ is a divalent radical of the general formula V

—(CR⁹R⁹—)_{y}, (V)

where
y is an integer from 1 to 6,
R⁹ is hydrogen or a hydrocarbon radical having 1-40 carbon atoms,
R³ are unsubstituted alkyl radicals having 1-40 carbon atoms,
R⁴ are —OR or —OH radicals, and
R are unsubstituted alkyl radicals having 1-40 carbon atoms,
   where in the polyorganosiloxane (P) the average ratio of the units of the general formulae Ia and Ib to the sum total of units of the general formulae lla and Ilb is 0.5 to 500 and polyorganosiloxane (P) has an average amine value of at least 0.1 mequiv/g,
(ii) 1 to 80 parts by weight of silicon compound (D) (based on 100 parts by weight of the polyorganosiloxane (P)) selected from a silicate compound (D1), the tetraalkoxysilicate of the general formula VI

R¹⁰O₄Si, (VI)

polysilicate compound (D2), which comprises at least 80 mol % of units of the general formulae VII and VIII and at least two units of the general formula VII

R¹⁰O₃Si_{1/2}, (VII)

R¹⁰O²Si_{2/2}, (VIII)

where
R¹⁰ are unsubstituted hydrocarbon radicals having 1-18 carbon atoms,

MQ silicone resin (D3), comprising at least 80 mol %, preferably at least 95 mol %, of units of the general formulae IX and X

R¹¹₃SiO_{1/2}, (IX)

SiO_{4/2}, (X)

where
R¹¹ has the meaning given for R¹ or R⁴ and the ratio of the units of the general formulae IX and X is 0.5 to 2.0, preferably 0.5 to 1.5, particularly preferably in the range from 0.6 to 1.0, and at most 10% by weight, preferably at most 3% by weight, more preferably at most 2.5% by weight, of the radicals R11 are —OR and —OH, and mixtures of any desired proportions of (D1), (D2) and (D3).

Preferably used in the process are oil-in-water emulsions of film-forming organopolysiloxanes (A) that may further comprise
(iii) protonating agent(S),
(iv) water (W),
(v) at most 5 parts by weight of emulsifier (E),
and
(vi) at least 5 parts by weight of an organic solvent or solvent mixture (L).

The composition (Z) preferably comprises cationic surfactants (B) selected from the group of the
(B1) quaternary alkyl-, alkenyl-, hydroxyalkyl-and alkylbenzeneammonium salts, par-ticularly those whose alkyl groups have 6 to 24 carbon atoms, particularly the halides, sulfates, phosphates and acetates,
(B2) alkylpyridinium, alkylimidazolinium and alkyloxazolinium salts, particularly those whose alkyl chain has up to 18 carbon atoms, specifically the halides, sulfates, phosphates and acetates,
(B3) ester-/amido-containing quaternary ammonium salts, particularly those having alkyl ester, alkenyl ester, alkylamido or alkenylamido groups, whose alkyl groups have 6 to 24 carbon atoms, particularly the halides, sulfates, phosphates and acetates.

Ester-/amido-containing quaternary ammonium surfactants (B3) are preferred.

The cationic surfactants used in the compositions (Z) may be one type of surfactant, but also several types of surfactants.

Examples of surfactants (B1) are
(a) monoalkyl-quaternary ammonium salts, such as
   the behenyltrimethylammonium salt,
   the stearyltrimethylammonium salt,
   the cetyltrimethylammonium salt and
   the hydrogenated tall oil alkyltrimethylammonium salt
and
(b) dialkyl-quaternary ammonium salts, such as
   dialkyl (C14-C18) dimethylammonium chloride,
   ditallowalkyldimethylammonium chloride,
   distearyldimethylammonium chloride and
   dicetyldimethylammonium chloride
   dioleyldimethylammonium chloride (available from Witco Corporation under the Adogen(R) 472 brand name).

One example of surfactants of formula (B2) is
1-methyl-1-stearoylamidoethyl-2-stearoylimidazolinium methylsulfate (available from

Witco Corporation under the Varisoft (R) brand name).

Examples of surfactants (B3) are
N,N-bis (stearoyloxyethyl)-N,N-dimethylammonium chloride,
N,N-bis (talloyloxyethyl)-N, N-dimethylammonium chloride,
N,N-bis (stearoyloxyethyl)-N-(2-hydroxyethyl)-N-methylammonium methylsulfate,
N,N-bis [ethyl (tallowate)]-N-(2-hydroxyethyl)-N-methylammonium methylsulfates,
difatty acid amidoamine-based products such as [alkyl/alkenyl-C(O)—NH—CH₂CH₂—N(CH₃)(CH₂CH₂OH)—CH₂CH₂—NH—C(O)-alkyl/alkenyl]+CH₃SO₄—(for example a product available from Witco Corporation under the Varisoft(R) 222 LT brand name).

The use of the preferred compositions (Z) makes it possible to significantly reduce the release of microfibers in the case of textiles, particularly polyester-containing textiles. At the same time, the use of the preferred compositions (Z) achieves a significant improvement in the softness as well as an improved dirt repellency of the treated textiles.

The alkyl radicals R, R¹, and R³ may be linear, cyclic, branched, saturated or unsaturated. Preferably, the alkyl radicals R, R¹, and R³ independently have 1-18 carbon atoms, in particular 1 to 6 carbon atoms, and particularly preferably are methyl radicals or ethyl radicals. A particularly preferred radical R, R1, and R3 is the methyl radical.

The divalent hydrocarbon radicals R⁵ may be linear, cyclic, branched, aromatic, saturated or unsaturated. The radicals R⁵ preferably have 1 to 6 carbon atoms, and particularly preferably are alkylene radicals, particularly propylene.

The monovalent hydrocarbon radicals R⁶ may be linear, cyclic, branched, aromatic, saturated or unsaturated. The radicals R⁶ preferably have 1 to 6 carbon atoms, and particularly preferably are alkyl radicals or alkanoyl radicals having 1 to 6 carbon atoms. Particularly preferred substituents R⁶ are hydrogen, the methyl radical, the ethyl radical, the cyclohexyl radical and the acetyl radical.

The monovalent hydrocarbon radicals R⁹ may be linear, cyclic, branched, aromatic, saturated or unsaturated. The radicals R⁹ preferably have 1 to 6 carbon atoms, and particularly preferably are alkyl radicals having 1 to 6 carbon atoms. Particularly preferred substituents R⁹ are hydrogen, the methyl radical, the ethyl radical and the cyclohexyl radical.

x preferably has a value of 0 to 18, particularly preferably 0 to 6, in particular 1 to 3.

Particularly preferred radicals R² are —CH₂N (R⁶)₂, —(CH₂)₃ N (R⁶)₂, —(CH₂)₃ N (R⁶)(CH₂)₂ N(R⁶)₂, in particular the aminopropyl radical, aminoethylaminopropyl radical and cyclohexylaminopropyl radical.

The polyorganosiloxane (P) is preferably constructed from at least 3, in particular at least 10, units and preferably at most 1000 units, in particular at most 500 units, of formulae Ia, Ib, IIa and IIb.

The polyorganosiloxane (P) preferably has a chain length of 3 to 1000 repeat units, in particular of 10 to 500 repeat units.

The viscosity of the polyorganosiloxane (P) is preferably 1 to 100 000 mPa·s, in particular 10 to 10 000 mPa·s (at 25° C. and at a shear rate of 10 1/s).

The ratio of the number of units la to the number of units Ib is selected such that the polyorganosiloxane (P) has at least an amine value of 0.1 mequiv/g of polyorganosiloxane (P), preferably at least 0.15 mequiv/g of polyorganosiloxane (P). The amine value of the polyorganosiloxane (P) is preferably at most 7 mequiv/g, particularly preferably at most 2 mequiv/g, in particular at most 0.6 mequiv/g.

The polyorganosiloxane (P) preferably has either exclusively units of formula lla, exclusively units of formula Ilb or a combination of units of formulae lla and Ilb.

The polyorganosiloxane (P) is produced by known chemical processes such as hydrolysis or equilibration.

The monovalent hydrocarbon radicals R¹⁰ of the tetraalkoxysilicate (D1) and of the polysilicate compound (D2) may be linear, cyclic, branched, aromatic, saturated or unsaturated. The radicals R¹⁰ preferably have 1 to 6 carbon atoms, and particularly preferably are alkyl radicals and phenyl radicals. Especially preferred radicals R10 are methyl, ethyl and propyl.

The polysilicate compound (D2) preferably comprises at least 90 mol %, in particular at least 95 mol %, of units of the general formulae VII and VIII.

The remaining units of the polysilicate compound (D2) may for example be units of the general formulae XI and XII

R¹⁰OSiO_{3/2}, (XI)

SiO_{4/2}, (XII)

where R¹⁰ has the above meanings.

Preferably, the MQ silicone resins (D3) have a viscosity at 25° C. of greater than 1000 mPas or are solids. The weight-average molecular weight determined by gel permeation chromatography (based on a polystyrene standard) of these resins is preferably 200 to 200 000 g/mol, in particular 1000 to 20 000 g/mol.

The MQ silicone resins (D3) used according to the invention are preferably soluble in benzene at a temperature of 25° C. and a pressure of 101.325 kPa to an extent of at least 100 g/l.

Based on 100 parts by weight of polyorganosiloxane (P), the oil-in-water emulsions of film-forming organopolysiloxanes (P) preferably comprise 3 to 50 parts by weight, particularly preferably 5 to 30 parts by weight, of the silicate compounds (D1) or (D2) or of the organopolysiloxane resin (D3).

The protonating agent(S) is preferably a monoprotic or polyprotic, water-soluble or water-insoluble, organic or inorganic acid.

Examples of suitable protonating agents(S) are formic acid, acetic acid, propionic acid, malonic acid, citric acid, hydrochloric acid, sulfuric acid, phosphoric acid or mixtures thereof. Preferred protonating agents are formic acid, acetic acid, sulfuric acid or hydrochloric acid. Particular preference is given to acetic acid.

The protonating agent is generally added in undiluted form or in the form of an aqueous solution.

The protonating agent is preferably added in an amount of from 0.05 to 2 mol of protons per mole of basic nitrogen atoms of the radicals R2.

The protonating agent is preferably added in an amount such that the oil-in-water emulsions reach a pH in a range from 3.5 to 7.0, preferably a pH between 3.5 and 6.0 and particularly preferably a pH between 3.5 and 5.0.

In the context of the present invention, the pH is preferably measured with an electrode in accordance with US Pharmacopeia USP 33 at 20° C.

The water is demineralized or salt-containing water, preferably demineralized water.

The oil-in-water emulsions of the film-forming organopolysiloxanes (A) preferably used in the process preferably comprise at most 3, particularly preferably at most 1, in particular at most 0.1, parts by weight of emulsifier (based on 100 parts by weight of organopolysiloxane (A)).

Emulsifiers (E) used may be all ionic and nonionic emulsifiers known to date, both individually and as mixtures of various emulsifiers, with which it has also been possible to date to produce aqueous dispersions, in particular aqueous emulsions of organopolysiloxanes (A).

Examples of anionic emulsifiers are:
1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) or propylene oxide (PO) units.
2. Sulfonates, particularly alkylsulfonates having 8 to 18 carbon atoms, alkylaryl-sulfonates having 8 to 18 carbon atoms, taurides, esters and monoesters of sulfosuccinic acid with monohydric alcohols or alkylphenols having 4 to 15 carbon atoms; these alcohols or alkylphenols may optionally also be ethoxylated with 1 to 40 EO units.
3. Alkali metal and ammonium salts of carboxylic acids having 8 to 20 carbon atoms in the alkyl, aryl, alkaryl or aralkyl radical.
4. Phosphoric acid partial esters and the alkali metal and ammonium salts thereof, particularly alkyl and alkaryl phosphates having 8 to 20 carbon atoms in the organic radical, alkyl ether and alkaryl ether phosphates having 8 to 20 carbon atoms in the alkyl or alkaryl radical and 1 to 40 EO units.

Examples of nonionic emulsifiers are:
5. Polyvinyl alcohol still having 5% to 50%, preferably 8% to 20%, of vinyl acetate units, having a degree of polymerization of 500 to 3000.
6. Alkyl polyglycol ethers, preferably those having 5 to 40 EO units and alkyl radicals of 8 to 20 carbon atoms.
7. Alkylaryl polyglycol ethers, preferably those having 5 to 40 EO units and 8 to 20 carbon atoms in the alkyl and aryl radicals.
8. Ethylene oxide/propylene oxide (EO/PO) block copolymers, preferably those having 8 to 40 EO or PO units.
9. Addition products of alkylamines having alkyl radicals of 8 to 22 carbon atoms with ethylene oxide or propylene oxide.
10. Fatty acids having 6 to 24 carbon atoms.
11. Alkyl polyglycosides of the general formula R*—O—ZO, in which R* is a linear or branched, saturated or unsaturated alkyl radical having an average of 8-24 carbon atoms and ZO is an oligoglycoside radical having an average of o=1-10 hexose or pentose units or mixtures thereof.
12. Natural substances and derivatives thereof, such as lecithin, lanolin, saponins, cellulose, cellulose alkyl ethers and carboxyalkyl celluloses whose alkyl groups each have up to 4 carbon atoms.
13. Linear organo (poly) siloxanes containing polar groups, particularly containing the elements O, N, C, S, P, Si, particularly those having alkoxy groups having up to 24 carbon atoms and/or up to 40 EO and/or PO groups.

Examples of cationic emulsifiers are:
14. Salts of primary, secondary and tertiary fatty amines having 8 to 24 carbon atoms with acetic acid, sulfuric acid, hydrochloric acid and phosphoric acids.
15. Quaternary alkyl- and alkylbenzeneammonium salts, particularly those whose alkyl groups have 6 to 24 carbon atoms, particularly the halides, sulfates, phosphates and acetates.
16. Alkylpyridinium, alkylimidazolinium and alkyloxazolinium salts, particularly those whose alkyl chain has up to 18 carbon atoms, specifically the halides, sulfates, phosphates and acetates.

Particularly suitable ampholytic emulsifiers are:
17. Amino acids having long-chain substitution, such as N-alkyldi (aminoethyl) glycine or N-alkyl-2-aminopropionic acid salts.
18. Betaines, such as N-(3-acylamidopropyl)-N,N-dimethylammonium salts having a C8-C18 acyl radical and alkylimidazolium betaines.

Preferred as emulsifiers are nonionic emulsifiers, particularly the alkyl polyglycol ethers listed above under 6., and cationic emulsifiers, particularly the quaternary alkyl- and alkylbenzeneammonium salts listed above under 15. The emulsifier may consist of one of the abovementioned emulsifiers or of a mixture of two or more abovementioned emulsifiers; it may be used in pure form or as a solution of one or more emulsifiers in water or organic solvents.

The oil-in-water emulsions of the film-forming organopolysiloxanes (A) preferably used in the process according to the invention comprise organic solvents or solvent mixtures (L), selected from monoalcohols or polyalcohols, aprotic ethers or mono-, di-or trialkoxyalkyl ethers having alkyl radicals of up to 7 carbon atoms.

Examples of monoalcohols or polyalcohols are methanol, ethanol, n-propanol, isopropanol, butanol, n-amyl alcohol, isoamyl alcohol, ethylene glycol, diethylene glycol, propylene glycol, dipropylene glycol, butyl glycol, hexylene glycol, heptylene glycol, octylene glycol and glycerol.

Examples of aprotic ethers are dioxane, tetrahydrofuran, diethyl ether or diisopropyl ether.

Mono-, di-or trialkoxyalkyl ethers are glycol ethers, such as ethylene glycol ethers, propylene glycol ethers or butylene glycol ethers.

Examples of ethylene glycol ethers are
ethylene glycol monomethyl ether (methyl glycol, 2-methoxyethanol, CH₃—O—CH₂CH₂—OH),
ethylene glycol monoethyl ether (ethyl glycol, 2-ethoxyethanol, CH₃CH₂—O—CH₂CH₂—OH)
ethylene glycol monopropyl ether (2-propoxyethanol, CH₃CH₂CH₂—O—CH₂CH₂—OH)
ethylene glycol monoisopropyl ether (2-isopropoxyethanol, (CH₃)₂CH—O—CH₂CH₂—OH)
ethylene glycol mono-n-butyl ether (2-butoxyethanol, CH₃CH₂CH₂CH₂—O—CH₂CH₂—OH)
ethylene glycol monophenyl ether (2-phenoxyethanol, C₆H₅—O—CH₂CH₂—OH)
ethylene glycol monohexyl ether (2-hexyloxyethanol, C₆H₁₁—O—CH₂CH₂—OH)
ethylene glycol monobenzyl ether (2-benzyloxyethanol, C₆H₅CH₂—O—CH₂CH₂—OH)
diethylene glycol monomethyl ether [2-(2-methoxyethoxy) ethanol, methyl carbitol, CH₃—O—CH₂CH₂—O—CH₂CH₂—OH]

diethylene glycol monoethyl ether [2-(2-ethoxyethoxy) ethanol, carbitol cellosolve, CH₃CH₂—O—CH₂CH₂—O—CH₂CH₂—OH]
diethylene glycol mono-n-butyl ether [2-(2-butoxyethoxy) ethanol, CH₃CH₂CH₂CH₂—O—CH₂CH₂—O—CH₂CH₂—OH]
triethylene glycol mono-n-butyl ether (butyltriglycol)
diethylene glycol diethyl ether (diethyl carbitol)
dibutylene glycol dibutyl ether (dibutyl carbitol)

Examples of propylene glycol ethers are
propylene glycol monomethyl ether (1-methoxy-2-propanol)
propylene glycol monoethyl ether (ethoxypropanol)
propylene glycol mono-n-butyl ether (1-butoxy-2-propanol)
propylene glycol monohexyl ether (1-hexoxy-2-propanol)
dipropylene glycol monoethyl ether
dipropylene glycol mono-n-butyl ether
dipropylene glycol monohexyl ether
tripropylene glycol monomethyl ether
tripropylene glycol mono-n-butyl ether
tripropylene glycol dimethyl ether

Examples of butylene glycol ethers are
butylene glycol monomethyl ether (1-methoxy-2-propanol)
butylene glycol monobutyl ether (ethoxypropanol)

Preferred examples of solvents or solvent mixtures (L) are isopropanol, ethylene glycol, diethylene glycol, propylene glycol, dipropylene glycol, butyl glycol, hexylene glycol, heptylene glycol, glycerol, ethylene glycol monomethyl ether, ethylene glycol monoethyl ether, ethylene glycol mono-n-butyl ether, ethylene glycol monohexyl ether, diethylene glycol monomethyl ether, diethylene glycol mono-n-butyl ether, propylene glycol monomethyl ether, propylene glycol monoethyl ether, propylene glycol mono-nbutyl ether or dipropylene glycol mono-n-butyl ether.

Especially preferred examples of solvents or solvent mixtures (L) are propylene glycol, dipropylene glycol, butyl glycol, ethylene glycol mono-n-butyl ether, ethylene glycol monohexyl ether, diethylene glycol mono-n-butyl ether, propylene glycol mono-n-butyl ether or dipropylene glycol mono-n-butyl ether.

The oil-in-water emulsions of the film-forming organopolysiloxanes (A) preferably used in the process preferably comprise 10 to 150 parts by weight, particularly preferably 20 to 120 parts by weight, 40 to 100 parts by weight, of solvents or solvent mixtures (L) (based on 100 parts by weight of organopolysiloxanes (A)).

The oil-in-water emulsions preferably used in the process are produced by mixing the combination of polyorganosiloxane (P), silicate compound (D1), polysilicate compound (D2) or MQ resin (D3), protonating agent(S), water (W), optionally emulsifier (E), organic solvent (L) and optionally with further components. The mixing is carried out at a temperature of preferably 10-80° C., particularly preferably 15-40° C., and a pressure of preferably 900 to 1100 hPa. The mixing may however also be carried out at higher or lower pressures.

In a favored procedure, the polyorganosiloxane (P) and the silicate compound (D1), polysilicate compound (D2) or MQ resin (D3) are premixed. This premix is then incorporated into a mixture of protonating agent(S), water (W), optionally emulsifier (E), organic solvent (L) and optionally with further components and subsequently diluted with additional water to form the oil-in-water emulsion.

The production may be performed batchwise or continuously.

Technologies for producing emulsions of organopolysiloxanes are known. Thus, the vigorous mixing and dispersing can be performed in rotor-stator stirrer apparatuses, colloid mills, high-pressure homogenizers, microchannels, membranes, jet nozzles and the like, or by means of ultrasound.

The oil-in-water emulsions can be diluted with water in all ratios. The emulsions may comprise water in amounts of preferably at least 10.0 parts by weight, in particular at least 100.0 parts by weight, preferably at most 5000 parts by weight, in particular at most 1000 parts by weight.

Regardless of the water content, the oil-in-water emulsions are clear to opaque liquids having a viscosity of preferably 5 to 10 000 mPa·s, particularly preferably 5 to 1000 mPa·s, in particular 10 to 500 mPa·s (at 25° C. and at a shear rate of 10 1/s).

Particular preference is given to the treatment and impregnation of any desired fibers, in particular natural and synthetic textiles and functional materials.

The compositions (Z) are preferably used during the washing process in a commercially available washing machine, in particular by adding them into the fabric softener compartment. This involves cleaning the laundry in a washing cycle and bringing it into contact with the composition (Z) in the fabric softening cycle. The textiles are thereby impregnated with the film-forming organopolysiloxanes (A), resulting in a reduced release of microfibers from textiles, particularly from polyester-containing textiles, in the subsequent washing process.

Furthermore, the compositions (Z) can not only be used to impregnate textiles, in particular polyester-containing textiles, in such a way that the release of microfibers in the washing process is reduced. Rather, the compositions (Z) can also achieve other effects, such as resistance to environmental influences, such as heat, sunlight, particularly UV radiation, oxidizing agents or an acidic environment, with the result that microfiber release is also reduced when the textiles are worn.

At the same time, the use of the compositions (Z) achieves a significant improvement in the softness as well as an improved dirt repellency of the treated textiles.

In the examples which follow, all figures for parts and percentages, unless stated otherwise, are based on weight.

Unless stated otherwise, the examples which follow are conducted at a pressure of the surrounding atmosphere, i.e. at about 1000 hPa, and at room temperature, i.e. about 20° C., or a temperature which is established on combination of the reactants at room temperature without additional heating or cooling.

The viscosities were measured on an “MCR 302” rheometer from Anton Paar in accordance with DIN EN ISO 3219:1994 and DIN 53019, using a cone-plate system (CP50-2 cone) with an opening angle of 2°. The instrument was calibrated with standard oil 10000 from the Physikalisch-Technischen Bundesanstalt [German National Metrology Institute]. The measurement temperature is 25.00° C.+/−0.05° C., the measurement time 3 min. The viscosity figure is the arithmetic mean of three independently conducted individual measurements. The measurement uncertainty of the dynamic viscosity is 1.5%. The shear rate gradient was chosen as a function of the viscosity and is given separately for each viscosity figure.

The amine value indicates how many mmol of KOH are equivalent to one gram of the substance to be determined. The amine value is determined in accordance with DIN 16945-Version 1989-03.

Examples:

The aminoalkyl group-containing polydimethylsiloxane (P-1) used in the test examples is a mixed hydroxy-/methoxydimethylsilyl-terminated copolymer composed of aminoethylaminopropylmethylsiloxane units and dimethylsiloxane units having a viscosity of 982 mPas (at 25° C. and at a shear rate of 10 1/s) and an amine value of 0.287 mmol/g.

The silicate compound (D-1) used in the test example is a mixture of tetraethoxysilicate of the general formula VI and a polysilicate compound having 2 units of the general formula VII and 1 to 7 units of the general formula VIII, where R10 is an ethyl radical, having an SiO2 content of 40% by weight.

The MQ silicone resin (D-3) used in the test example is a silicone resin that is solid at 20° C. and comprises units of the general formula IX and X in a ratio of 0.37 to 0.63 having a molecular weight Mn =2700 g/mol (weight-average molecular-weight based on a polystyrene standard by gel permeation chromatography).

Production of the different formulations:

Example 1: Oil-in-water emulsion of a film-forming organopolysiloxane E1

17.0 g of a mixture of 13.6 g of aminoalkyl group-containing polydimethylsiloxane (P-1) and 3.4 g of MQ silicone resin (D-3) are added, with stirring at room temperature, to 7.0 g of demineralized water, 7.0 g of ethylene glycol monobutyl ether (commercially available from BASF), 2.9 g of ethylene glycol monohexyl ether (commercially available from BASF) and 0.13 g of acetic acid (80% aqueous solution available from Brenntag), then a further 65.97 g of demineralized water is stirred in. A clear, colorless emulsion (E1) is obtained.

Emulsion E1 comprises 17% by weight of the film-forming organopolysiloxane A1.

Example 2: Oil-in-water emulsion of a film-forming organopolysiloxane E2 7.0 g of demineralized water, 12.0 g of n-butyl glycol (available under the Ethylene glycol butyl ether trade name from Sigma-Aldrich) and 0.4 g of acetic acid (80% aqueous solution available from Brenntag) are initially charged at room temperature and mixed. 17.0 g of a mixture of 16.1 g of aminoalkyl group-containing polydimethylsiloxane (P-1) and 0.9 g of silicate compound (D-1), and 63.6 g of demineralized water are stirred in successively. A translucent, colorless emulsion (E2) is obtained.

Emulsion E2 comprises 17% by weight of the film-forming organopolysiloxane A2.

Example 3: (Non-inventive) oil-in-water emulsion of a linear organopolysiloxane VE3:

7.0 g of demineralized water, 4.0 g of isotridecyl octaethoxylate, commercially available under the Lutensol TO 8 trade name (from BASF), 2.0 g of isotridecyl pentaethoxylate, commercially available under the Lutensol TO 5 trade name (from BASF) and 0.4 g of acetic acid (80% aqueous solution available from Brenntag) are initially charged at room temperature and mixed. 34.0 g of the aminoalkyl group-containing polydimethylsiloxane (P-1) and 52.6 g of demineralized water are stirred in successively. A translucent, whitish emulsion (VE3) is obtained.

Emulsion VE3 does not comprise any film-forming organopolysiloxane.

Example 4:

Compositions Z1, Z2 (inventive) comprising
(A) film-forming organopolysiloxanes,
(B) cationic surfactants
and
(C) water
and compositions VZ3 and VZ4 (non-inventive).

TABLE 1
Aqueous formulations Z1, Z2, VZ3, VZ4

| | | | Cationic | | Electrolytes, |
|---|---|---|---|---|---|
| | Oil-in-water | | surfactant | | perfumes, dyes, |
| | emulsion | | B1 ***) | Water | preservatives |
| Z1 *) | 2.9 | g of E1 | 3.8 g | 42.6 g | 0.7 g |
| Z2 *) | 2.9 | g of E2 | 3.8 g | 42.6 g | 0.7 g |
| VZ3 **) | 1.5 | g of VE3 | 3.8 g | 44.0 g | 0.7 g |

| | | | | |
|---|---|---|---|---|
| VZ4 **) | — | 3.8 g | 45.7 g | 0.5 g |

*) inventive
**) non-inventive
***) B1: N,N-bis[ethyl(tallowate)]-N-(2-hydroxyethyl)-N-methylammonium methyl-sulfates (90% solution in isopropanol), commercially available under the Stepantex ® VK90 trade name (from Stepan)

The (inventive as well as non-inventive) formulations are produced by heating the water to 50° C. The cationic surfactant which has previously been melted at 50° C. and vigorously stirred is added at this temperature with vigorous stirring. Stirring is continued 10 until a homogeneous mixture results. The mixture is cooled to 30° C. and the oil-in-water emulsion E1, E2 or VE3 and further ingredients are added. For VZ4, only the cationic surfactant and further ingredients are formulated.

Example 5:

For the experiments which follow, 50 ml of the compositions Z1, Z2, VZ3 and VZ4 are diluted with demineralized water to 2000 ml of the use concentration.

A black, 100% polyester fabric having a grammage of 270 g/m2 is used.

The fabric is pretreated by being prewashed in a washing machine (Miele Softtronic W 1935) at 40° C., main washing program without a detergent. It is then punched out into circles having a diameter of 113 mm. The edges are melted off using a flame in order to prevent fraying.

The punched-out polyester fabrics are pretreated with the diluted compositions Z1, Z2, VZ3 or VZ4 by placing one fabric in each case flat in a beaker, stirring it by hand with 19 ml of the diluted composition Z1, Z2, VZ3, VZ4 or just water as a blank value (BL), squeezing it between two rollers and line-drying it overnight. Finally, the fabrics are ironed using a commercially available iron (approx. 20 sec., synthetic program).

In order to simulate a washing cycle, the experiments are conducted in a Linitester device (from Hanau). To this end, 200 ml of a washing liquid (this being 4 g of Ariel liquid detergent dissolved in one liter of water), 20 steel balls and a pretreated polyester fabric are placed in a metal beaker and treated for 90 minutes at 60° C. in the Linitester device.

The washing liquid is filtered off using a Buchner funnel with a round paper filter (from VWR, 55 mm diameter, pore size: 31-50 um). The fabric is rinsed with 100 ml of water, and the rinsing water is filtered using the same filter.

The filter paper is photographed, and the number of microfibers filtered off is evaluated electronically (ImageJ image processing software); output as area occupied by the microfibers on the filter paper.

The result is the average of twelve individual measurements.

TABLE 2
Released microfibers

| | Released microfibers |
|---|---|
| Composition | [mm²] |
| Z1 *) | 0.83 mm² |
| Z2 *) | 0.95 mm² |
| VZ3 **) | 1.79 mm² |
| VZ4 **) | 1.10 mm² |
| BL **) | 1.01 mm² |

*) inventive
**) non-inventive

It is clearly apparent from Table 2 that the release of microfibers from the polyester 5 fabric is reduced when using compositions Z1 and Z2 in comparison with the blank value BL (no finishing) or VZ4 (finishing with only the cationic surfactant). When using formulation VZ3 which does not comprise any film-forming polysiloxane, significantly more microfibers are released in comparison with the blank value BL and with the use of compositions Z1 and Z2.

1-9. (canceled).

10. A process for reducing the release of microfibers during the washing process of textiles
which are pretreated before the washing process with composition (Z) comprising
(A) at least 0.1 parts by weight and at most 10.0 parts by weight of film-forming organopolysiloxanes, which are used in the form of their aqueous emulsions that comprise
(i) 100 parts by weight of aminoalkyl group-containing polyorganosiloxane (P) that is liquid at 20° C. and comprises at least 80 mol % of units selected from units of the general formulae Ia, Ib, IIa and IIb
R¹₂SiO_{(2/2)}, (Ia)
R¹ₐR²SiO_{(3-a)/2}, (Ib)
R³₃SiO_{(1/2)}, (IIa)
R³₂R⁴SiO_{(1/2)}, (IIb)
in which
a is 0 or 1,
R¹ is unsubstituted alkyl radicals having 1-40 carbon atoms,
R² is an aminoalkyl radical of the general formula III
—R⁵—NR⁶R⁷, (III)
where
R⁵ is a divalent hydrocarbon radical having 1-40 carbon atoms,
R⁶ is a monovalent hydrocarbon radical having 1-40 carbon atoms, hydrogen or an alkanoyl radical and
R⁷ is a radical of the general formula IV
—(R⁸—NR⁶)ₓR⁶, (IV)
where
X is an integer from 0 to 40 and
R⁸ is a divalent radical of the general formula V
—(CR⁹R⁹—)_{y}, (V)
where
y is an integer from 1 to 6,
R⁹ is hydrogen or a hydrocarbon radical having 1-40 carbon atoms,
R³ are unsubstituted alkyl radicals having 1-40 carbon atoms,
R⁴ are —OR or —OH radicals, and
R are unsubstituted alkyl radicals having 1-40 carbon atoms, where in the polyorganosiloxane (P) the average ratio of the units of the general formulae Ia and Ib to the sum total of units of the general formulae Ila and IIb is 0.5 to 500 and polyorganosiloxane (P) has an average amine value of at least 0.1 mequiv/g,
(ii) 1 to 80 parts by weight of silicon compound (D) (based on 100 parts by weight of the polyorganosiloxane (P)) selected from silicate compound (D1), the tetraalkoxysilicate of the general formula VI
R¹⁰O₄Si, (VI)
polysilicate compound (D2), which comprises at least 80 mol % of units of the general formulae VII and VIII and at least two units of the general formula VII
R¹⁰O₃Si_{1/2}, (VII)
R¹⁰O₂Si_{2/2}, (VIII)
where
R¹⁰ are unsubstituted hydrocarbon radicals having 1-18 carbon atoms, MQ silicone resin (D3), comprising at least 80 mol % of units of the general formulae IX and X
R¹¹₃SiO_{1/2}, (IX)
SiO_{4/2}, (X)
where
R¹¹ has the meaning given for R¹ or R⁴
and the ratio of the units of the general formulae IX and X is 0.5 to 2.0 and at most 10% by
weight of the radicals R¹¹ are —OR and —OH,
and mixtures of any desired proportions of (D1), (D2) and (D3),
(B) at least 1 part by weight and at most 20 parts by weight of cationic surfactants and
(C) at least 30 parts by weight and at most 99 parts by weight of water.

11. The process as claimed in claim 10, in which the radicals R¹ and R³ are methyl radicals.

12. The process as claimed in claim 10, in which the radical R is a methyl radical.

13. The process as claimed in claim 10, in which the polysilicate compound (D2) comprises at least 90 mol % of units of the general formulae VII and VIII and the remaining units are units of the general formulae XI and XII
R¹⁰OSiO_{3/2}, (XI)
SiO_{4/2}, (XII)
where R¹⁰ has the meanings given in claim 1.

14. The process as claimed in claim 10, in which the MQ silicone resins (D3) have a viscosity at 25°° C. of greater than 1000 mPas (measured at 25°° C. and at a shear rate of 10 1/s) or are solids.

15. The process as claimed in claim 10, in which the cationic surfactants (B) are selected from the group of the
(B1) quaternary alkyl-, alkenyl-, hydroxyalkyl-and alkylbenzeneammonium salts,
(B2) alkylpyridinium, alkylimidazolinium and alkyloxazolinium salts and
(B3) ester-/amido-containing quaternary ammonium salts.

16. The process as claimed in claim 10, in which the oil-in-water emulsions of the film-forming organopolysiloxanes (A) comprise organic solvents or solvent mixtures (L), selected from monoalcohols or polyalcohols, aprotic ethers or mono-, di-or trialkoxyalkyl ethers having alkyl radicals of up to 7 carbon atoms.
